(19) United States
(12) Patent Application Publication
(10) Pub. No.: US 2003/0135473 A1
(43) Pub. Date: Jul. 17, 2003

(54) Method, according to which a customer accesses monetary-value data from a charging point

(76) Inventors: Jurgen Lang, Bergisch Gladbach (DE); Bernd Meyer, Konigswinter (DE)

Correspondence Address: CONNOLLY BOVE LODGE & HUTZ, LLP, 1220 N MARKET STREET, P O BOX 2207, WILMINGTON, DE, 19899

(21) Appl. No.: 10/258,226

(22) PCT Filed: Apr. 24, 2001
(86) PCT No.: PCT/DE01/01552

(30) Foreign Application Priority Data
Apr. 27, 2000 (DE) 100 20 565.8

(51) Int. Cl. H04K 1/00; H04L 9/00; G06F 17/60

(52) U.S. Cl. 705/77; 705/64

(57) ABSTRACT

The invention is characterized in that a random number (X) and a payment identification number (PID) which contain information about the customer are generated in the charging point.

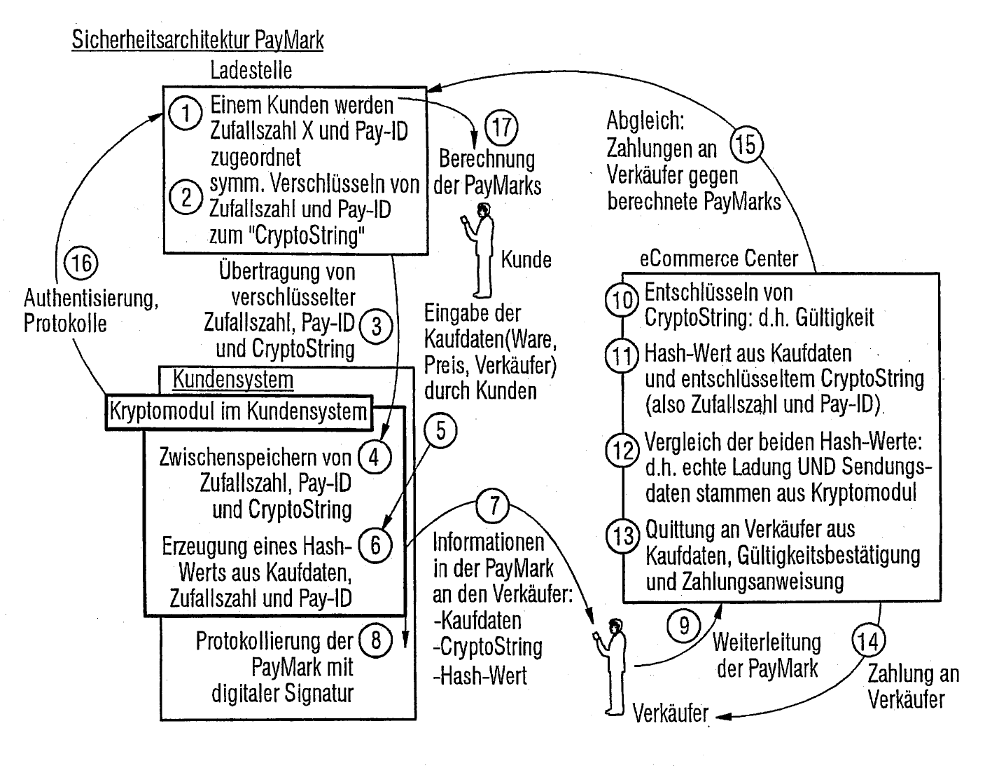

The invention relates to a method according to which a customer accesses monetary-value data from a loading station.

Especially with payment transactions that are carried out via the Internet, there is a need to pay quickly and securely for services rendered and goods shipped.

Electronic payment transactions have to meet high requirements in terms of data security and user authenticity.

According to the invention, this objective is achieved in that a random number and a payment identification number containing data about the customer are generated in the loading station.

Additional advantages, special features and an advantageous embodiment of the invention ensue from the subordinate claims and from the representation below of a preferred embodiment with reference to the drawing.

The drawing shows a schematic diagram of process steps that can be advantageously integrated into a security architecture of the payment transaction.

The invention relates especially to the production of PayMarks, that is to say, monetary-value crypto-information.

Functional Mode of PCF PayMark

PCF PayMark is an expansion of PC franking (PCF). With a few additions to the system, it is possible to generate so-called PayMarks, that is to say, monetary-value crypto-information, instead of postage indicia. These PayMarks can be submitted, for example, in electronic form within the scope of the e-Commerce Center, but also in another form (for example, paper) to a seller as payment for a purchase transaction. The seller can have the validity of these monetary-value PayMarks verified in an e-Commerce Center and then receives the corresponding value reimbursed from this e-commerce center.

The security architecture of PCF PayMark is configured as follows:

Explanations About the Sequence

In principle, the process shown involves a cyclic process which, depending on whether it is a credit or debit procedure of PCP, is executed regularly or irregularly for reloading debit amounts. The actual start of the cyclic process is the stop that is designated with no. 16 in the figure, namely, the authentication of the customer system vis-à-vis a central “loading station”. For reasons of a better overview, however, in this depiction, the cyclic process only starts with the first process step after the authentication has taken place;

1. A random number X and a so-called Pay ID PID containing information about the customer, about his/her creditworthiness for micropayment purchases and about the period of validity of the PID are generated in the loading station

2. In the loading station, the random number X and the Pay ID PID are encrypted (e.g. symmetrically) to form a so-called “CryptoString” in such a way that only the e-Commerce Center is capable of decrypting the random number and the PID on the basis of this CryptoString.

3. The random number X, Pay ID PID and the CryptoString are encrypted in such a way (e.g. asymmetrically) that only the crypto-module in the customer system is capable of decrypting this information.

4. The random number X, the Pay ID PID and the CryptoString are stored temporarily in the crypto-module. Subsequently, the communication with the loading station can be terminated.

5. Within the scope of thc purchase transaction, the customer enters information (e.g. goods/product, price, supplier/seller, date, etc.) into the crypto-module.

6. The crypto-module generates a bash value, among other things, on the basis of the purchase data, the random number, the Pay ID PID (and optionally additional information).

7. The customer system generates a so-called PayMark, that is to say, a character string with crypto-information containing, among other things, the following information: the purchase data in plain text, the temporally stored CryptoString and the generated hash value. This PayMark can be transmitted, for example, electronically to the seller (for example, with an e-mail or on-line via the World-Wide Web), but it can also be transmitted to the seller via other data carriers or else printed out on paper.

8. The crypto-module digitally signs the PayMark with all of the security-relevant information with its own private key and stores it in a journal file in the customer system.

9. The seller receives the PayMark as a monetary-value confirmation for a payment and submits it to the e-Commerce Center for purposes of verification of its validity and for effectuating a payment to him/her. In special embodiments of the system, it is also possible for the PayMark to be transmitted directly to the e-Commerce Center, bypassing the seller.

10. In a first verification step, the CryptoString, which had been encrypted in such a way that only the e-Commerce Center could decrypt it, is decrypted to form the random number X and the Pay ID PID.

11. Like the customer system, the e-Commerce Center now generates a hash value, among other things, on the basis of the transmission-specific data, the random number decrypted from the CryptoString and the Pay ID PID (and optionally additional information).

12. By comparing the hash value that the e-Commerce Center itself has just generated with the hash value contained in the PayMark, it is ascertained whether the (reliable) crypto-module in the customer system was indeed used to produce the PayMark, thus confirming the validity of the PayMark.

13. The e-Commerce Center issues and sends the seller a receipt consisting of the purchase data, the validity confirmation of the PayMark and the confirmation of the payment instruction.

14. The payment transaction to the seller is effectuated, optionally with a time delay.

15. For settlement purposes, the payments of the e-Commerce Center made to the seller are compared to the values that were available to a customer for the production of PayMarks.

16. The values that a customer can use for the production of PayMarks are made available to him/her via the loading station. For this purpose, an authentication of the customer is necessary with which the journal data of the already produced PayMarks (see Item 8) are also transmitted.

17. Depending on the credit or debit process, the produced PayMarks are either charged to the customer ahead of time (loading amount by means of the debit method) or retrospectively on the basis of the journal data. Subsequently, it is possible to continue again with Item 1, that is to say, with the preparation of a new random number X and a new Pay ID PID.

1. A method according to which a customer accesses monetary-value data from a loading station, whereby a random number (X) and a payment identification number (PID) containing data about the customer are generated in the loading station, whereby a customer system generates a character string with crypto-information, whereby a seller receives the character string as a monetary-value amount for a payment, whereby the seller submits the character string to an e-Commerce Center for purposes of verification of its validity and for effectuating a payment, whereby the Commerce Center decrypts thc character string, characterized in that the e-Commerce Center generates a hash value from the random number decrypted from the character string and from the payment identification number (PID).

2. The method according to claim 1, characterized in that, in the loading station, the random number (X) and the payment identification number (PID) are combined to form a cryptographic unit in such a way that only an external e-Commerce Center is capable of decrypting the random number (C) and the payment identification number (PID) from the cryptographic unit.

3. The method according to one of both claims 1 or 2, characterized in that the random number (X), the payment identification number (PID) and the crypto-graphic unit are stored temporarily in a crypto-module.

4. The method according to claim 3, characterized in that the customer enters information into the crypto-module during a purchase transaction.

5. The method according to one or more of claims 3 or 4, characterized in that the crypto-module generates a hash value.

6. The method according to claim 5, characterized in that the hash value is formed with thc inclusion of the data of the purchase, of the random number (X) and of the payment identification number (PID).

7. The method according to one or more of the preceding claims, characterized in that the character string contains the purchase data in plain text, the cryptographic unit and the hash value.

8. The method according to one or more of the preceding claims, characterized in that the crypto-module digitally signs the character string and stores it in a journal file.

9. The method according to one or more of the preceding claims, characterized in that the character string is transmitted directly to the e-Commerce Center.

10. The method according to one or more of the preceding claims, characterized in that the character string is encrypted in such a way that only the e-Commerce Center can decrypt it.

11. The method according to one or more of the preceding claims, characterized in that the e-Commerce Center, by comparing the hash value that it has generated with the hash value contained in the character string, ascertains whether a crypto-module suitable for payment was indeed used to produce the character string.

12. The method according to one or more of the preceding claims, characterized in that the e-Commerce Center sends the seller a receipt.

13. The method according to one or more of the preceding claims, characterized in that the e-Commerce Center makes a payment to the seller.

14. The method according to claim 13, characterized in that the payment made to the seller is compared to the value that was available to the customer for the production of the cryptographic character string.

15. The method according to one or more of the preceding claims, characterized in that the customer receives values that it can use for the production of cryptographic character strings.

16. The method according to claim 15, characterized in that the customer receives the values after an authentication.

17. The method according to one or both of claims 15 and 16, characterized in that the customer pays the monetary sums for the values before the cryptographic character string is created.

18. The method according to one or more of claims 15 and 16, characterized in that the customer pays the monetary sums for the values after the cryptographic character string is created.
